(19) United States
(12) Patent Application Publication
(10) Pub. No.: US 2016/0119468 A1
(43) Pub. Date: Apr. 28, 2016

(54) METHOD AND SYSTEM FOR RAPID INTERNET PROTOCOL (IP) COMMUNICATION SESSION SETUP USING INTERACTIVE PUSH NOTIFICATIONS

(71) Applicant: VONAGE NETWORK LLC, Holmdel, NJ (US)

(72) Inventors: Tzahi Efrati, Hoboken, NJ (US); Craig Caruso, Staten Island, NY (US)

(21) Appl. No.: 14/524,429

(22) Filed: Oct. 27, 2014

(51) Int. Cl. H04M 3/02; H04L 29/08; H04L 29/06; H04M 7/00

(52) U.S. Cl. CPC H04M 3/02; H04M 7/006; H04L 67/26; H04L 65/1003; H04L 65/608

(57) ABSTRACT

Systems and methods for rapid IP telephony communications session setup using interactive push notifications are provided herein. In some embodiments, a method may include receiving a connection request from a first device to setup an IP telephony communications session with a second device, transmitting a request to send a push notification message including telecommunication invitation data to the second device to notify a user of the second device of the connection request, receiving a first response from the second device indicating acceptance of the connection request, sending an indication to the first device that the connection request has been accepted at the second device, receiving a second response from the second device that is used to complete the IP telephony communications session connection between the first and second devices, and connecting the second device with the first device to establish the IP telephony communications session based on the second response.

### BACKGROUND OF THE INVENTION

1. Field of the Invention

Embodiments consistent with the present invention generally relate to a method and system for rapid call setup using interactive push notifications in an internet protocol (IP) communication session.

2. Description of the Related Art

In modern telecommunication systems, calls between user devices use internet protocol (IP) communication sessions (e.g., Voice-over IP (VoIP)) that are established across the Internet and IP networks. User devices such as cellular or mobile devices (tablets, phones, and the like) often experience delays when attempting to setup a VoIP call. In some instances, the delay is significant and the caller may prematurely discontinue the call under an assumption that the recipient is unavailable to receive a call.

For example, when an incoming call arrives at a mobile device with a locked screen, the user receiving the call must press on the incoming call notification, unlock the screen, and wait for the installed telecommunication app to launch before the telecommunication app can begin to respond to the call. Since such a call flow may take a long time, the caller may prematurely cancel the call under an assumption the recipient is unavailable. In addition, if a telecommunication application running on the mobile device is not running or running in the background, in may need to be launched or brought to the foreground before receiving the call. This may require registration or re-registration of the device with the VoIP service provider which can take additional time.

Accordingly, there is a need for a method and system for rapid call setup using interactive push notifications to prevent premature termination in an IP communication session.

### SUMMARY OF THE INVENTION

Systems and methods for rapid Internet Protocol (IP) telephony communications session setup using interactive push notifications are provided herein. In some embodiments, a method for rapid Internet Protocol (IP) telephony communications session setup using interactive push notifications may include receiving a connection request from a first device to setup an IP telephony communications session with a second device, transmitting a request to send a push notification message including telecommunication invitation data to the second device to notify a user of the second device of the connection request, receiving a first response from the second device indicating acceptance of the connection request, sending an indication to the first device that the connection request has been accepted at the second device, receiving a second response from the second device that is used to complete the IP telephony communications session connection between the first and second devices, and connecting the second device with the first device to establish the IP telephony communications session based on the second response.

In some embodiments, a computer-implemented method for rapid Internet Protocol (IP) telephony communications session setup using interactive push notification may include receiving a push notification message for a request to establish an IP communication session with a first device over an IP telephony communications system, extracting connectivity data from the push notification message, generating a first response directed to the IP telephony communications system using the extracted connectivity data, sending the first response to the IP telephony communications system notifying the first device that the IP communication session request was accepted, initiating an IP telephony communication application, and sending a second response to complete the IP telephony communications session connection with the first device.

In some embodiments, a system for rapid Internet Protocol (IP) telephony communications session setup using interactive push notification may include a media relay configured to receive a connection request from a first device to setup an IP telephony communications session with a second device and send a first media to the first device, a push notification payload generator configured to generate a push notification message directed to a second device with telecommunication invitation data to complete the IP telephony communications session, at least one proxy server configured to: receive a first response from the second device; instruct the media relay to modify the first media sent to notify the first device of the first response; receive a second response from the second device; and connect the second device with the first device to establish the IP telephony communications session based on the second response.

In some embodiments, an apparatus for rapid Internet Protocol (IP) telephony communications session setup using interactive push notification may include a push notification handler module configured to receive a push notification message for a request to establish an IP communication session with a first device over an IP telephony communications system and extract connectivity data from the push notification message; a response receipt module configured to generate a first response message directed to the IP telephony communications system using the extracted connectivity data and send the first response to the IP telephony communications system to notify the first device that the IP communication session request was accepted; and a call connection module configured to send a second response to complete the IP telephony communications session connection with the first device.

Other and further embodiments of the present invention are described below.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a diagram of a communication system in accordance with one or more exemplary embodiments of the invention;

FIG. 2 is a detailed block diagram of a communication system including a push notification server in accordance with one or more embodiments of the invention;

FIG. 3 is a block diagram of a recipient device with a push notification handler module in accordance with one or more embodiments of the invention;

FIG. 4 is a call flow diagram of an exemplary method generating a response receipt and call completion in accordance with one or more embodiments of the invention;

FIG. 5 is a flow diagram of an exemplary method for completing an IP call with a response receipt from the recipient device in accordance with one or more embodiments of the invention;

FIG. 6 is a flow diagram of an exemplary method for completing an IP call by receiving a push notification and sending a response receipt in accordance with one or more embodiments of the invention; and

FIG. 7 is a depiction of a computer system that can be utilized in various embodiments of the present invention.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present invention are directed to methods, apparatus, and systems for rapid call setup using interactive push notifications to prevent premature termination in an IP communication session. More specifically, embodiments of the present invention are directed to generating a response receipt in an Internet Protocol (IP) telephony communications via an IP network. In some embodiments, the methods and systems use interactive push notifications for setting up an IP telephony communication (i.e., an IP call). Typically, push notifications enable a mobile application stored on a mobile device to notify a user of new messages or events even when the user is not actively using the mobile application. When a device receives a push notification, the mobile application's icon and a message may appear in the status bar. When the user taps the notification, they are sent to the mobile application. Non-limiting examples of push notification services include: APPLE™ PUSH NOTIFICATION SERVICE from IOS 7.x (APNS7) and earlier, MICROSOFT™ PUSH NOTIFICATION SERVICE (MPNS), or GOOGLE™ CLOUD MESSAGING (GCM) service. New and improved push notification services provide interactive push notifications that provide additional functionality and support larger data payloads. For example, some may be interactive push notifications that may support packet data payloads of 2 kilobytes (kB)-4 kB or more (e.g., APPLE™ PUSH NOTIFICATION SERVICE in IOS 8.x (APNS8) and GCM).

The interactive push notification (hereinafter “push notification message”) is sent from the IP telephony network, or from a push notification service at the request of the IP telephony network, to a recipient device. In some embodiments, the recipient device may be connected to the IP telephony network via a cellular network. The recipient device extracts call setup information from the payload of the interactive push notification to immediately respond to an incoming IP call. The recipient device can immediately send a response receipt that the push notification was successfully received. In some embodiments, the response receipt may be in the form of a Session Description Protocol (SDP), a Session Initiation Protocol (SIP) message, and the like. The response receipts may be sent to a corresponding VoIP server that subsequently notifies the caller device through a media change (e.g., change in ring back tone). The response receipt allows the caller device to be quickly notified of the communication session completion progress, in addition to initiating the call setup to connect the caller device and recipient device. While the notification is sent to the caller device, the recipient device extracts the push notification payload for launching the IP communications application that opens corresponding sockets and sends a response receipt in the form of an SDP or SIP message, for example, to the IP network to complete the IP call. In other embodiments, the response receipt message may be utilize other VoIP protocols such as H.323, Extensible Messaging and Presence Protocol (XMPP), and the like.

Push notification messages are Internet-based communications where a recipient device or software client is configured to subscribe to channels by a push notification server as part of a push notification service. The push notification server subsequently sends data down the assigned channel subscribed by the user. Push notifications include synchronous conferencing, instant messaging, Simple Mail Transfer Protocol (SMTP) e-mail, HTTP server pushes, HTTP polling, and the like. As described herein, push notifications will generally refer to interactive push notifications with a larger data payload. APNS8 and GCM services are two non-limiting examples of push notification services that use interactive push notifications with a larger data payload. The push notification service used in embodiments consistent with the present invention allows users to interact with a push notification using a handler module described below to deploy instructions to send a response receipt, and execute an IP telephony application in a single input (i.e., accepting the call). The handler module allows the mobile device operating system to execute the instructions even if the recipient device is a locked.

SDP is a format for describing streaming media initialization parameters. The Internet Engineering Task Force (IETF) published a revised specification as an IETF Proposed Standard as RFC 4566 in July 2006. As described in RFC 4566, SDP is intended for describing multimedia communication sessions for the purposes of session announcement, session invitation, and parameter negotiation. SDP does not deliver media itself but is used for negotiation between end points of media type, format, and all associated properties. The set of properties and parameters are often called a session profile.

In some embodiments, telephony communications are effectuated over a packet-based data network. As discussed herein, a message may include one or more packets carrying signaling data such as media information, response codes, and the like. Signaling that is conducted in the packet-based data network is preferably executed using SIP. However, other messaging protocols besides SIP may be used to connect to the IP telephony system 120. SIP is a popular communication protocol for initiating, managing, and terminating media (e.g., voice, data and video) sessions across packet-based data networks that typically use the Internet Protocol (IP), of which VoIP is an example. The details and functionality of SIP can be found in the Internet Engineering Task Force (IETF) Request for Comments (RFC) Paper No. 3261 entitled, “SIP: Session Initiation Protocol,” that is herein incorporated in its entirety by reference.

The embodiments discussed herein may include devices using mobile communications such VoIP, which is utilized to establish and provide voice communications over a data network using the IP. Businesses and individuals implement VoIP by installing the necessary equipment and service (i.e., a “high speed” network or broadband connection) to access a VoIP service provider and activating this telecommunication service. Calls from a VoIP subscriber device to a destination device may be routed via a number of inter-connected networks, such as via the VoIP service provider network, mobile telephone service provider networks, and existing and traditional telecommunications system more commonly referred to as the Public Switched Telephone Network (PSTN) or Plain Old Telephone Service (POTS).

VoIP service providers may provide mobile or desktop VoIP applications (apps) that users can install on their smartphone or other type of mobile or stationary computing devices, or may provide VoIP Telephone/Device Adapters or Terminal Adapters (TA) that can be used with traditional hardwire telephones as described further below. Such apps also include over the top (OTT) applications. OTT describes a category of applications where content is delivered without a multiple system operator involved in the control or redistribution of the content.

At least a portion of the call may be transmitted as packets over an IP network, via wireless local area network (WLAN) based on the Institute of Electrical and Electronics Engineers' (IEEE) 802.11x standards for example, rather than over traditional mobile phone mobile communication technology standards (e.g., 2G, 3G, and the like). By transmitting voice as packet data over an IP network, these mobile apps can allow a user to make calls to another OTT client or an off-net destination. They may be used when the user is connected to a base station over the mobile operator's cellular network, over a third-party's WLAN, 802.11x access point, over IEEE 802.13x access point, and the like.

In other embodiments, an electronic device (e.g., analog phone, IP telephone, and the like) that is not connected to a cellular network is coupled to a terminal adapter. The terminal adapter is configured to receive push notifications from the cellular network and communicates with an IP network and VoIP service providers. The terminal adapter completes a connection with the IP network after receiving push notifications from the cellular network.

In the following description, references will be made to an “IP telephony device.” This term is used to refer to any type of device which is capable of interacting with an IP telephony system to complete an audio or video telephone call or to send and receive push notifications, and other forms of communications. An IP telephony device could be an IP telephone, a computer running IP telephony software, a telephone adapter which is itself connected to a normal analog telephone, or some other type of device capable of communicating via data packets. An IP telephony device could also be a cellular telephone or a portable computing device that runs a software application that enables the device to act as an IP telephone. Thus, a single device might be capable of operating as both a cellular telephone and an IP telephone.

The following description will also refer to a mobile telephony device. The term “mobile telephony device” is intended to encompass multiple different types of devices. In some instances, a mobile telephony device could be a cellular telephone. In other instances, a mobile telephony device may be a mobile computing device, such as the APPLE IPHONE™ or an ANDROID™ device that includes both cellular telephone capabilities and a wireless data transceiver that can establish a wireless data connection to a data network. Such a mobile computing device could run appropriate application software to conduct VOIP telephone calls via a wireless data connection via the terminal adapter. Thus, a mobile computing device, such as an APPLE IPHONE™, a RIM BLACKBERRY™ or a comparable device running the GOOGLE ANDROID™ or MICROSOFT WINDOWS MOBILE™ operating systems are examples of a mobile telephony device. In still other instances, a mobile telephony device may be a device that is not traditionally used as a telephony device, but which includes a wireless data transceiver that can establish a wireless data connection to a data network. Examples of such devices include the APPLE IPOD TOUCH™ and the IPAD™. Such a device may act as a mobile telephony device once it is configured with appropriate application software.

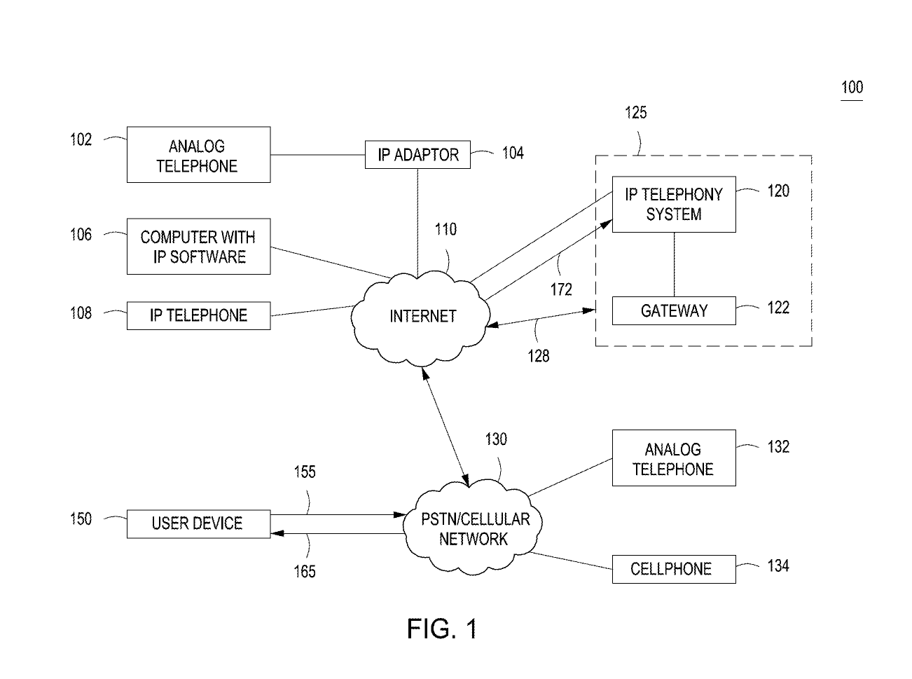

FIG. 1 is a diagram of a communication system 100 in accordance with one or more exemplary embodiments of the invention. The communication system 100 includes an Internet 110, an IP telephony system 120, a PSTN/cellular network (hereinafter cellular network) 130, and a user device 150. The user device 150 may be any one of the devices shown in the communications system 100: an analog telephone 102 with IP adapter 104, computer with IP software 106, IP telephone 108, or cellphone 134 and those discussed above. As will be discussed in detail further below, the user device 150 is configured to receive a push notification (arrow 165) and send a response receipt (arrow 155). The user device 150 is described as a cellular device connected to the cellular network 130. However, alternative embodiments for devices without a cellular connection may directly connect to the Internet 110 to reach the IP telephony network 125 (shown as arrows 172 and 128).

The IP telephony system 120 enables connection of telephone calls between its own customers and other parties via data communications that pass over the Internet 110. The IP telephony system 120 and a gateway 122 are part of an IP telephony network 125. The Internet 110 is commonly the Internet, although the IP telephony system 120 may also make use of private data networks. The IP telephony system 120 is connected to the Internet 110. A push notification service (not shown) sends and receives push notification messages through the Internet 110. In addition, the IP telephony system 120 is connected to a publicly switched telephone network (PSTN) or cellular network 130 via the gateway 122. The cellular network 130 may also be directly coupled to the Internet 110 through one of its own internal gateways (not shown). Thus, communications may pass back and forth between the IP telephony system 120 and the cellular network 130 through the Internet 110 via a gateway maintained within the cellular network 130.

The gateway 122 allows users and devices that are connected to the cellular network 130 to connect with users and devices that are reachable through the IP telephony system 120, and vice versa. In some instances, the gateway 122 would be a part of the IP telephony system 120. In other instances, the gateway 122 could be maintained by a third party. In other embodiments, the gateway 122 is a wireless gateway that facilitates the communication between the IP telephony system 120 and the cellular network 130. The gateway 122 allows data from the IP telephony system 120 and a generated push notification from the IP telephony network 125 to be communicated to the Internet 110.

An analog telephone 102 is communicatively coupled to the Internet 110 via an IP adapter 104. The IP adapter 104 converts analog signals from the analog telephone 102 into data signals that pass over the Internet 110, and vice versa. Analog telephone devices include but are not limited to standard telephones and document imaging devices such as facsimile machines. A configuration using an IP adapter 104 is common where the analog telephone 102 is located in a residence or business. Other configurations are also possible where multiple analog telephones share access through the same IP adapter. In those situations, all analog telephones could share the same telephone number, or multiple communication lines (e.g., additional telephone numbers) may be provisioned by the IP telephony system 120.

In addition, a customer could utilize a soft-phone client running on a computer with IP software 106 to place and receive IP based telephone calls, and to access other IP telephony systems (not shown). In some instances, the soft-phone client could be assigned its own telephone number. In other instances, the soft-phone client could be associated with a telephone number that is also assigned to an IP telephone 108, or to an IP adapter 104 that is connected to one or more analog telephones 102.

Users of the communication system 100 are able to access the service from virtually any location where there is an available connection to the Internet 110. Thus, a customer/user could register with an IP telephony system provider in the U.S., and that customer could then use an IP telephone 108 located in a country outside the U.S. to access the services. Likewise, the customer could also utilize a computer outside the U.S. that is running a soft-phone client to access the IP telephony system 120.

Customers of the IP telephony system 120 can place and receive telephone calls using an IP telephone 108 that is connected to the Internet 110. Such an IP telephone 108 could be connected to an Internet service provider via a wired connection or via a wireless router. In some instances, the IP telephone 108 could utilize the data channel of a cellular telephone system to access the Internet 110.

A third party using an analog telephone 132 which is connected to the cellular network 130 may call a customer of the IP telephony system 120. In this instance, the call is initially connected from the analog telephone 132 to the PSTN network/cellular network 130, through the gateway 122 to the IP telephony system 120. The IP telephony system 120 then routes the call to the customer's IP telephony device. A third party using a cellphone 134 could also place a call to an IP telephony system customer, and the connection would be established in a similar manner, although the first link would involve communications between the cellphone 134 and a cellular network.

In operation, a call originating from IP telephone 108 over the Internet 110, for example, requests a connection to the user device 150 via the IP telephony system 120. The IP telephony system 120 retrieves customer and device information to determine that a number is mapped to a specific device on the cellular network. The IP telephony system 120, or a push notification service at the request of the IP telephony system 120, then sends a push notification (arrow 165) to the user device 150. The push notification data payload is generated by the IP telephony system 120 and routed through the Internet 110 (shown as arrow 128) to the Internet 110 using push notification services such as APNS8. In other embodiments, the user device 150 may be connected to the Internet 110 via Wi-Fi or other networking.

The push notification contains connectivity data that may include IP addresses, port numbers, device identifiers, subscriber identifiers, authentication information, time to connect, SDP data, and the like. The user device 150 sends a response receipt (arrow 155) back to the IP telephony system 120 to confirm receipt of the push notification. Substantially simultaneously, while the response receipt is being sent, the user device 150 executes an IP telephony application to open sockets on the user device 150 and connect to the IP telephony network 125 based on the connectivity data extracted and parsed from the push notification. The response receipt may be a message an SDP response or SIP successful (2xx) response, provisional (1xx), or error (4xx) message encapsulating SDP data that is routed through the cellular network 130 to the Internet to reach the IP telephony network 125 (shown as arrow 172). In some embodiments, the response receipt message is sent based on an IP address extracted from the push notification received by the user device 150.

In alternative embodiments, the user device 150 may be locked and requires a user to unlock the user device 150 to complete the communication session with the calling device (e.g., analog telephone 102). In such an embodiment, the locked phone may simply prevent audio and/or video communication until the user device 150 is unlocked while maintaining an active communication session. Once the user unlocks the phone, audio and/or video communication may continue between the devices.

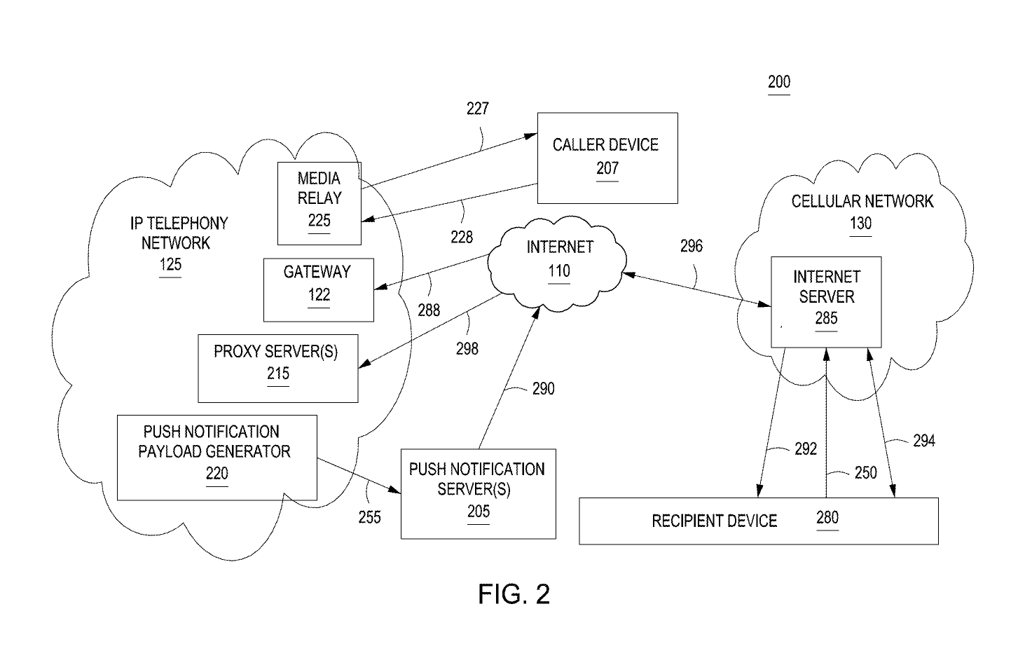

FIG. 2 is a detailed block diagram of a communication system 200 including a push notification server 205 in accordance with one or more embodiments of the invention. The communication system 200 may be used to communicate among devices and as part of the communication system 100 described above in FIG. 1.

The communication system 200 comprises a caller device 207, an IP telephony network 125, a cellular network 130, and a recipient device 280. The caller device 207 and recipient device 280 may each be any one of the devices shown in the communications system 100: an analog telephone 102 with IP adapter 104, computer with IP software 106, IP telephone 108, cellphone 134 or user device 150. For ease of explanation, the recipient device 280 will be described below as a smartphone capable of running applications. However, alternative embodiments include electronic devices that are coupled directly to the Internet 110 and not reliant on a cellular connection to connect to the IP telephony network 125 such as a computer with IP software 106, a tablet, a laptop and the like.

The cellular network 130 comprises cellular towers and servers (not shown) as well as an Internet server 285. The cellular towers and servers facilitate voice and data communications between user devices, the Internet, and completing calls with POTS telephone devices. The Internet server 285 operates as a gateway to access the Internet 110 and exchange data between the Internet 110 and the recipient device 280 and other devices communicatively coupled to the cellular network 130.

The IP telephony network 125 comprises at least one proxy server 215, a push notification payload generator 220, a gateway 122, and a media relay 225. The at least one proxy server 215 receives and processes requests to connect various electronic communication devices communicatively coupled to the IP telephony network 125. The requests may be SIP messages or HTTP messages. The push notification payload generator 220 creates push notifications carrying a connectivity data payload, such as SDP data. In some embodiments, the push notification payload generator 220 generates payload data for insertion into a push notification by a push notification service. In some embodiments, the payload data generated by payload generator 220 may be transmitted in a request sent to a push notification service to notify a user of the recipient device 280 of the connection request. The recipient device 280 receives the connectivity data payload and extracts the payload to connect to the proxy server 215. In some embodiments, the gateway 122 coordinates with the cellular network 130 to send communication session data and push notifications (shown as arrow 292). The push notifications contain a data payload to complete a call initiated by the caller device 207.

The media relay 225 coordinates communication data streams to exchange data between user devices (e.g., caller device 207 and recipient device 280). The communication data streams (arrow 227 and 228) may include an initial media ring back notification that notifies the caller device 207 of changes in communication session connection states. For example, the communication session connection state may change from when a call is first initiated state to when a response receipt (arrow 250) is received from the recipient device 280 (i.e., response state). The change in media data allows the caller device 207 to identify that the communication session state has advanced in progress and notifies the caller not to prematurely end the call session. For example, the initial media ring back tone (i.e., a first media) may change from when the caller device 207 first initiates a communication session request to a different ring back tone (i.e., a second media) when the response receipt is received by the IP telephony network 125. In another example, the media change is a modification of an image displayed on the recipient device 280 (i.e., for a video communication session). In either example, the change in sound or visual cues provides communication session progress updates to the user of the caller device 207. In other embodiments,

Upon receiving a request for a communication session from the caller device 207, the push notification payload generator 220 generates a push notification payload including call connectivity data. The push notification message, or a request to send a push notification, is sent to push notification server 205 (shown as via arrow 255). The push notification is subsequently sent across the Internet 110 (shown as via arrow 290). In some embodiments, the push notification server 205 may be included as part of the IP telephony network 125. In other embodiments, the push notification is sent across the Internet 110 directly to the recipient device 280 via a different Internet provider.

Upon receiving the push notification (arrow 292), the recipient device sends a response receipt (arrow 250) to the IP telephony network 125. The response receipt triggers a media change to the caller device 207. Substantially simultaneously, the recipient device 280 extracts the payload from the push notification to establish the communication session. The recipient device 280 automatically executes the installed VoIP application and connects to the caller device 207 and IP telephony network 125 based on the payload data.

Once the communication session is established, communication data streams (arrows 227 and 228) may include video and audio packets, for streaming communication between the caller device 207 and recipient device 280 in the communications session. The data packets are routed through the IP telephony network 125, the Internet 110 (arrow 296), and cellular network 130 to the media relay 225. The data packets for the communications session may include streaming audio and video transmitted using the real-time transport protocol (RTP) to and from the recipient device (arrow 294). The details and functionality of RTP can be found for example, in the Internet Engineering Task Force (IETF) Request for Comments Paper No. 3550. In alternative embodiments, the media relay 225 is used to communicate between three or more user devices in a conference session across the IP telephony network 125. Further embodiments include peer-to-peer connections that do not rely on the media relay 225.

As will be discussed further below, the recipient device includes various modules for decoding/analyzing received push notification messages (arrow 292), sending a response receipt, extracting push notification payload data, and launching/executing an IP telephony application. The IP telephony application then connects to the IP network 125 and media relay 225 and completes the establishment of a communication session between the caller device 207 and recipient device 280 using a proxy server connection (arrow 298) and media relay connection (arrows 227 and 228).

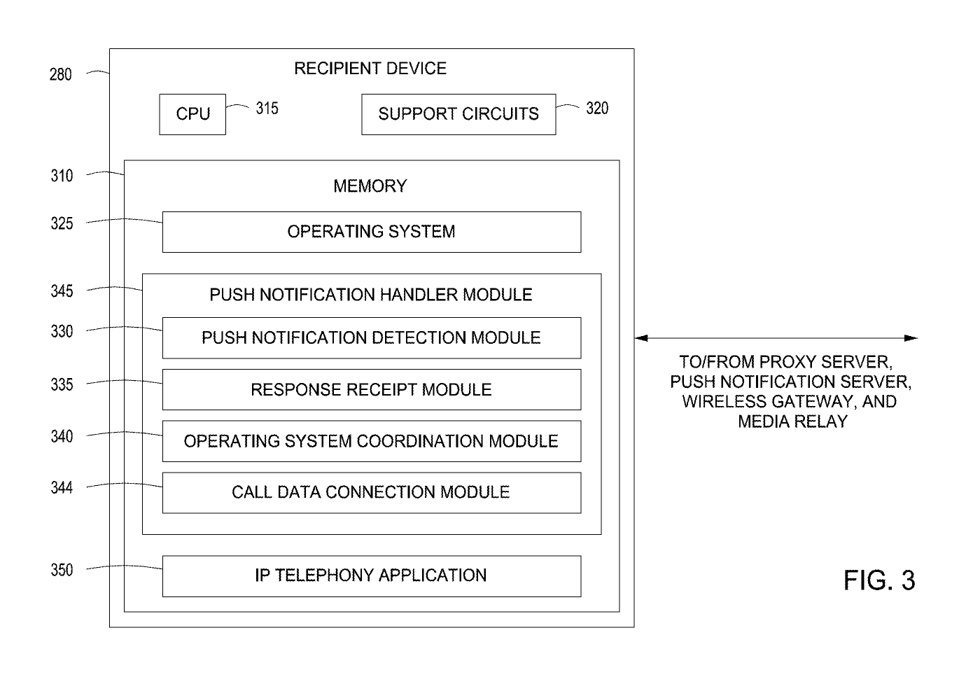

FIG. 3 is a block diagram of a recipient device 280 with a push notification handler module 345 in accordance with one or more embodiments of the invention. The recipient device 280 comprises a central processing unit (CPU) 315, support circuits 320, and memory 310. The CPU 315 may be any commercially available processor, microprocessor, microcontroller, and the like. The support circuits 320 comprise well known circuits that provide functionality to the CPU 315 such as clock circuits, cache, power supplies, I/O circuits, touch input, displays, and the like.

The memory 310 may comprise random access memory, read-only memory, removable disk memory, flash memory, and various combinations thereof. The memory 310 is sometimes referred to a main memory and may in part, be used as cache memory or buffer memory. The memory 310 stores instructions comprising an operating system 325, a push notification handler module 345, and an IP telephony application 350. The operating system 325 coordinates communication among the modules and the CPU 315 that executes the instructions stored in memory 310. The operating system 325 also responds to calls from the push notification handler module 345 to send a response receipt and execute the IP telephony application 350. The response receipt may be used to indicate the receipt of the push notification and launch of the IP telephony application 350. The response receipt may an SDP response or other type of message including client device connection information or client device status (e.g., an SIP 1xx, 2xx, or 4xx response message). In some embodiments, the push notification handler module 345 may be integrated with the IP telephony application 350 such that only the push notification handler module 345 passively awaits the reception of a push notification prior to executing or deploying the IP telephony application 350 to complete a communication session.

The push notification handler module 345 comprises a push notification detection module 330, a response receipt module 335, an operating system coordination module 340, and a call data connection module 344. The push notification detection module 330 validates and extracts/retrieves call data from received push notifications. Validation may include instructions to authenticate the push notification as originating from the IP telephony network 125. Authentication may access predetermined keys, tokens, or encryption data stored in the memory 310 that verifies a push notification message is from an IP service provider on the IP telephony network 125 to request a call or connection.

The response receipt module 335 comprises a set of instructions to generate a response receipt message back to the IP telephony network 125. The response receipt message acknowledges receipt of the request for a communication session. Upon receipt of the response receipt message, the IP telephony network 125 notifies the caller device 207 that the communication session is pending so the user does not prematurely terminate the call. The response receipt created by the response receipt module 335 may also include telecommunications data such as IP addresses and ports, codecs, connection information, and the like for completing the IP communications session. In some embodiments, should the recipient or recipient device decline the push notification, the response receipt module 335 may instruct the IP telephony network 125 to forward the call to voicemail (i.e., connect the caller device 207 to a voicemail service).

The operating system coordination module 340 includes instructions to facilitate communication with the operating system 325. The operating system coordination module 340 allows the operating system 325 to send the response receipt message as well as launch at least a portion of the IP telephony application 350. In some embodiments, the operating system coordination module 340 facilitates communication between the push notification handler module 345 and the IP telephony application 350 through the operating system 325. For example, the operating system coordination module 340 may translate data from the IP telephony application to retrieve SDP data for determining where or what format to send the response receipt by the response receipt module 335.

The call data connection module 344 is communicatively coupled to the IP telephony application 350 and operating system 325. The call data connection module 344 launches at least a portion of the IP telephony application 350 to send an SIP response code such as an “SIP OK 200” message to the proxy server 215 using data from the payload of the received push notification message.

The IP telephony application 350 then opens corresponding sockets on the recipient device 280 and connects to the IP network 125 to exchange audio/video streams via the media relay 225. Thus, the establishment of a communication session between the caller device 207 and recipient device 280 is completed using a proxy server connection (arrow 298) and media relay connection (arrows 227 and 228).

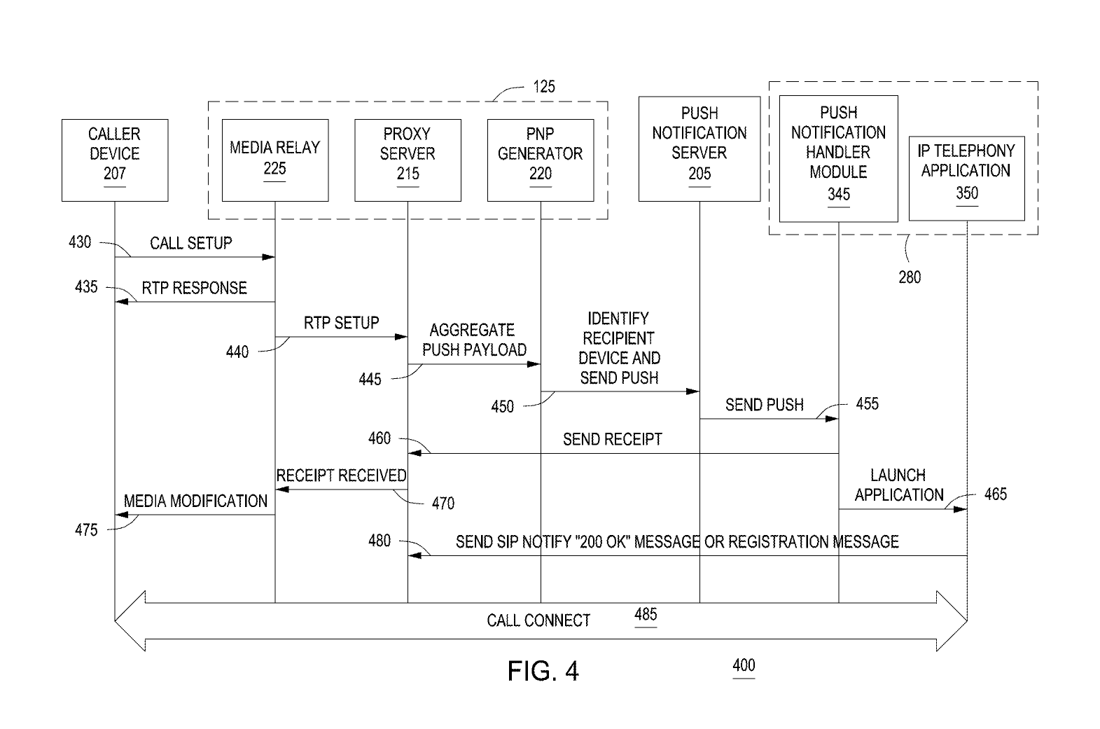

FIG. 4 is a call flow diagram of an exemplary method 400 generating a response receipt and call completion in accordance with one or more embodiments of the invention. The call flow diagram shows the various legs of establishing a communication session with the interactive push notification. Each leg of the call is identified via the network (or component thereof) that it passes through including the caller device 207, media relay 225, proxy server 215, push notification payload (PNP) generator 220, push notification server 205, and recipient device 280. In some embodiments, the gateway 122 is integrated with the proxy server 215 and PNP generator 220 as part of the IP telephony network 125. In further embodiments, without a cellular connection, the PNP generator 220 may be directly coupled to a push notification server 205 and Internet 110 to connect to the recipient device 280.

As will be described further below, the method 400 is a combination of the steps from the methods 500 and 600. At 430, the caller device 207 initiates a communication session request to the IP telephony network 125 for connecting to the recipient device 280. The media relay 225 sends a RTP response at 435 such as a first ring back tone to the caller device 207 while the call is initiated.

At 440, a RTP setup process is coordinated with the proxy server 215. At 445, payload data for the push notification is aggregated and sent to the PNP generator 220. The aggregation of payload data may be executed and stored by a set of instructions on the media relay 225 and/or the proxy server 215. The media relay 225 may gather for example the IP address of the devices, codecs, and other media-related parameters. The parameters may be stored as text, encrypted data, JavaScript Object Notation (JSON), and Extensible Markup Language (XML). Furthermore, the proxy server 215 may aggregate session-related parameters such as caller ID, call ID, contact information, account information, and the like. In some embodiments, the payload data that is aggregated/collected may include, for example, IP addresses, codec information, SDP data, and the like.

The PNP generator 220 identifies the recipient device 280 and sends the push notification across push notification servers 205 at 450 across a network (e.g., Internet 110). In some embodiments, the push notification is sent across the Internet 110 to communicate with an Internet server 285 in the cellular network 130. In such an embodiment, the cellular network 130 sends the push notification at 455 to the push notification handler module 345. The push notification handler module 345 sends a response receipt at 460. The may occur prior to registration of the recipient device 280 with the IP telephony network 125. The response receipt may include SIP or SDP data such as an “OK 200” message. In some embodiments, the push notification handler module 345 retrieves SDP data from the IP telephony application 350. At 465, the push notification handler module 345 executes the IP telephony application 350 that opens the necessary sockets and ports on the recipient device 280.

The response receipt is received by the IP telephony network 125 at 470. In some embodiments, the response receipt is sent/received at or about the same time the push notification handler module 345 executes the IP telephony application 350 that opens the necessary sockets and ports on the recipient device 280. In some embodiments, the response receipt may act as a registration (e.g., and SIP REGISTER message) to register the recipient device 280 with the IP telephony network 125. At 475, the media relay 225 then may send a RTP response to modify the media (i.e., a media modification) and to notify the caller device 207 that the recipient device is acknowledging the communication session request. The media modification may be a change in ring back tone or an image displayed on the caller device 207. At 480, the IP telephony application 350 sends an SIP message such as “200 OK” or a registration message to complete the connection/call. At 485, the communication session is established between the caller device 207 and recipient device 280.

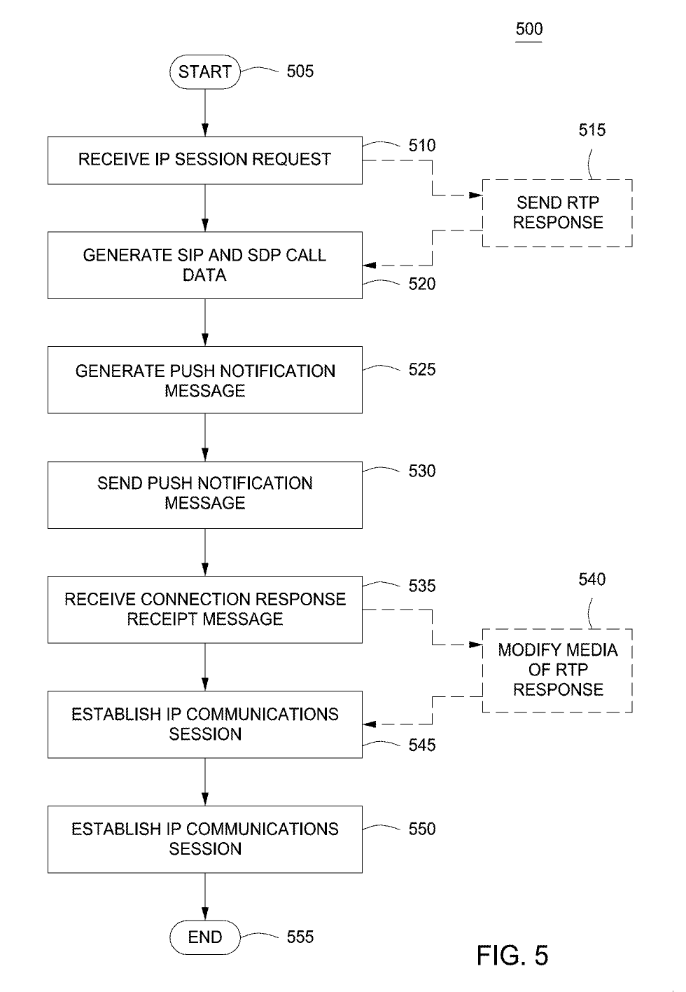

FIG. 5 is a flow diagram of an exemplary method 500 for completing an IP call with a response receipt from the recipient device in accordance with one or more embodiments of the invention.

In some embodiments, the method 500 is implemented by the IP telephony network 125. The method 500 begins at step 505 and continues to step 510. At step 510, a request from a calling device (e.g., caller device 207) for an IP communication session with a recipient device (e.g., recipient device 280) is received. The request is received by an IP network (e.g., IP telephony network 125). In some optional embodiments, the request initiates the sending of a media response using RTP at step 515 that is sent to the caller device 207.

At step 520, SIP and SDP call data is generated for insertion into a push notification (e.g., interactive push notification). The SIP and SDP call data includes connectivity information such as IP addresses and response codes for connection by the recipient device 280. At step 525, the push notification message is generated by a push notification server 205.

At step 530, the push notification message is sent to the recipient device 280. The push notification is routed through the Internet 110. In some embodiments, the push notification is then routed through the Internet 110 and the cellular network 130.

At step 535, the IP telephony network 125 receives a response receipt message confirming the recipient device 280 has received the request for connection via the push notification. The response receipt may be an SIP, SDP, or other VoIP protocol message carrying data. The method 500 proceeds to step 545.

Optionally, the method 500 may continue to step 540 to modify the media of the RTP response to the caller device 207. The modification provides notification to the caller device 207 as to the establishment progress of the communication session and confirmation the recipient device 280 has been contacted. The method 500 then continues to step 545.

At step 545, the IP network 125 receives an SIP message from the recipient device 280. The SIP message may be an SIP “OK 200” message or other message to establish the communications session. The SIP message may indicate the IP telephony application 350 has been executed as well as notify the IP telephony network 125 of a request to establish the communication session from the recipient device 280. At step 550, an IP communications session is established across the IP telephony network 125 between the caller device 207 and recipient device 280. The method 500 then ends at step 555.

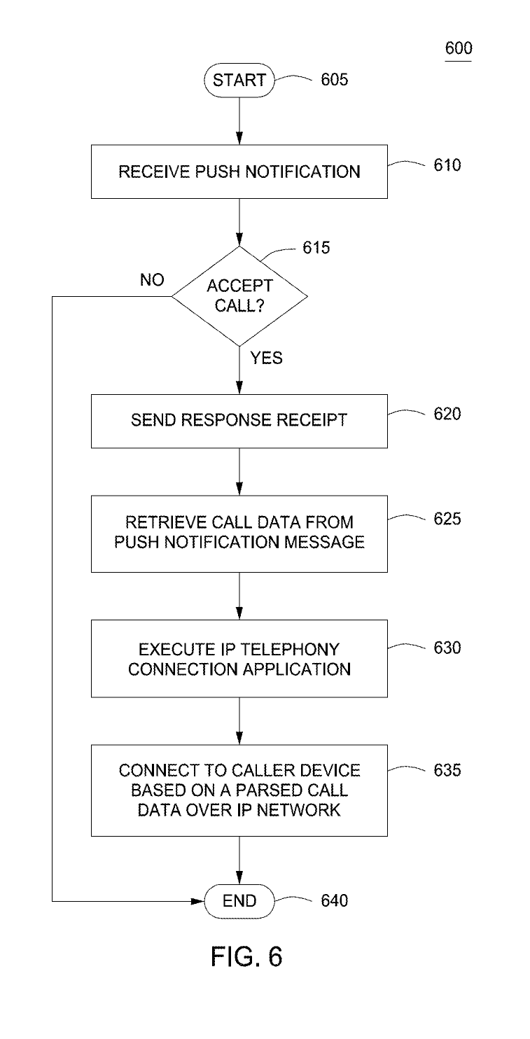

FIG. 6 is a flow diagram of an exemplary method 600 for completing an IP call by receiving a push notification and sending a response receipt in accordance with one or more embodiments of the invention. The method 600 is implemented by the embodiments discussed above in FIGS. 1-5 and the push notification handler module 345 of a recipient device 280.

The method 600 begins at step 605 and continues to step 610. At step 610 a push notification message is received by the recipient device. The push notification message may be received from the Internet 110 or through a connection to a cellular network such as the cellular network 130 (e.g., long term evolution (LTE), 3G, 4G, GSM, and the like) coupled to the Internet 110.

At step 615, a determination is made whether the call or communication request is accepted. The push notification service used in embodiments consistent with the present invention allows users to interact with a push notification using a handler module described below to deploy instructions to send a response receipt, and execute an IP telephony application in a single input (i.e., accepting the call). The handler module allows the mobile device operating system to execute the instructions even if the recipient device is a locked. The push notification may be displayed as a badge or other icon on the recipient device. In some embodiments, a selection of the push notification (e.g., the badge or icon) indicates acceptance of the call. In other embodiments, selection of push notification may display a prompt to the user to accept or decline the call. If a determination is made that the request is declined by the user, the method 600 proceeds to step 640 and ends. In some embodiments, the caller device 207 may be directed to voice mail or other message administration system. If however, a determination is made that the communication request is accepted by the user, the method 600 proceeds to step 620.

At step 620, a response receipt is generated and sent to the IP telephony network 125 acknowledging the push notification was received. The response receipt may an SDP response or other type of message including client device connection information or client device status (e.g., an SIP 1xx, 2xx, or 4xx response message). Such connectivity data is used by the IP telephony network 125 to facilitate establishing the IP communication session.

At step 625, call data is parsed or extracted from the push notification message. The call data is retrieved by the push notification handler module 345. Call data includes information from an SIP INVITE message such as a call ID, caller ID, supported codecs, caller telephony service account information, and caller device IP address. At step 630, the IP telephony application 350 is executed or deployed on the recipient device 280. The execution of the IP telephony application 350 is determined by the push notification handler module 345 interacting with the operating system 325 of the recipient device 280. In other words, the push notification handler module 345 initializes the IP telephony application 350 via the operating system 325 of the recipient device 280.

At step 635, the caller device 207 is connected based on the parsed call data over the IP telephony network 125. Based on the parsed call data, the push notification handler module 345 will select the relevant codecs for the media streams and open corresponding sockets to the IP addresses to establish the communication session. The caller device 207 and recipient device 280 exchange data in a communication session that is facilitated by connections to a proxy server 215 and media relay 225 through the Internet 110 and cellular network 130. The media relay 225 exchanges streaming audio and/or video between the recipient device 280 and calling device 270. The method 600 then ends at step 640.

Alternatively, from step 630, the user may have to unlock the recipient device 280 prior to completion of connecting to the recipient device 280. The method 600 then proceeds through step 635 and ends at step 640.

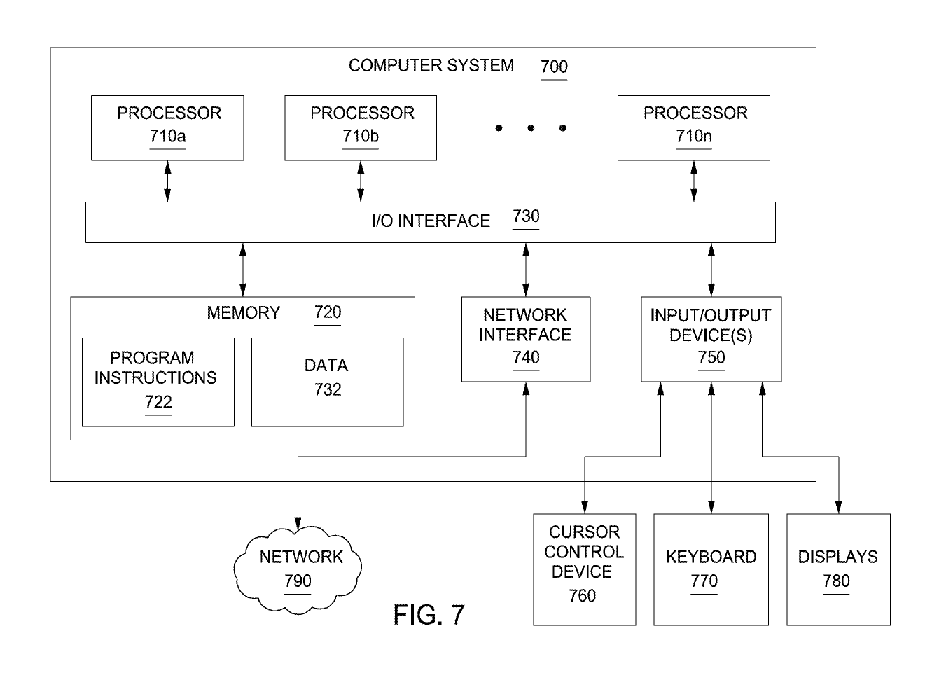

FIG. 7 is a depiction of a computer system 700 that can be utilized in various embodiments of the present invention. The computer system 700 includes substantially similar structure comprising servers or electronic devices in the aforementioned embodiments.

Various embodiments of methods and system authenticating users for completing communication sessions using response receipts and push notifications, as described herein, may be executed on one or more computer systems, which may interact with various other devices. One such computer system is computer system 700 illustrated by FIG. 7, which may in various embodiments implement any of the elements or functionality illustrated in FIGS. 1-6. In various embodiments, computer system 700 may be configured to implement methods described above. The computer system 700 may be used to implement any other system, device, element, functionality or method of the above-described embodiments. In the illustrated embodiments, computer system 700 may be configured to implement methods 500, and 600 as processor-executable executable program instructions 722 (e.g., program instructions executable by processor(s) 710) in various embodiments.

In the illustrated embodiment, computer system 700 includes one or more processors 710a-710n coupled to a system memory 720 via an input/output (I/O) interface 730. Computer system 700 further includes a network interface 740 coupled to I/O interface 730, and one or more input/output devices 760, such as cursor control device 670, keyboard 770, and display(s) 780. In some embodiments, the keyboard 770 may be a touchscreen input device.

In various embodiments, any of the components may be utilized by the system to authenticate a push notification to establish an IP communications session as described above. In various embodiments, a user interface may be generated and displayed on display 780. In some cases, it is contemplated that embodiments may be implemented using a single instance of computer system 700, while in other embodiments multiple such systems, or multiple nodes making up computer system 700, may be configured to host different portions or instances of various embodiments. For example, in one embodiment some elements may be implemented via one or more nodes of computer system 700 that are distinct from those nodes implementing other elements. In another example, multiple nodes may implement computer system 700 in a distributed manner.

In different embodiments, computer system 700 may be any of various types of devices, including, but not limited to, personal computer systems, mainframe computer systems, handheld computers, workstations, network computers, application servers, storage devices, a peripheral devices such as a switch, modem, router, or in general any type of computing or electronic device.

In various embodiments, computer system 700 may be a uniprocessor system including one processor 710, or a multiprocessor system including several processors 710 (e.g., two, four, eight, or another suitable number). Processors 710 may be any suitable processor capable of executing instructions. For example, in various embodiments, the processors 710 may be general-purpose or embedded processors implementing any of a variety of instruction set architectures (ISAs). In multiprocessor systems, each of processors 710 may commonly, but not necessarily, implement the same ISA.

System memory 720 may be configured to store program instructions 722 and/or data 732 accessible by processor 710. In various embodiments, system memory 720 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 720. In other embodiments, program instructions and/or data may be received, sent or stored upon different types of computer-accessible media or on similar media separate from system memory 720 or computer system 700.

In one embodiment, I/O interface 730 may be configured to coordinate I/O traffic between processor 710, system memory 720, and any peripheral devices in the device, including network interface 740 or other peripheral interfaces, such as input/output devices 750. In some embodiments, I/O interface 730 may perform any necessary protocol, timing or other data transformations to convert data signals from one component (e.g., system memory 720) into a format suitable for use by another component (e.g., processor 710). In some embodiments, I/O interface 730 may include support for devices attached through various types of peripheral buses, such as a variant of the Peripheral Component Interconnect (PCI) bus standard or the Universal Serial Bus (USB) standard, for example. In some embodiments, the function of I/O interface 730 may be split into two or more separate components, such as a north bridge and a south bridge, for example. Also, in some embodiments some or all of the functionality of I/O interface 730, such as an interface to system memory 720, may be incorporated directly into processor 710.

Network interface 740 may be configured to allow data to be exchanged between computer system 700 and other devices attached to a network (e.g., network 790), such as one or more external systems or between nodes of computer system 700. In various embodiments, network 790 may include one or more networks including but not limited to Local Area Networks (LANs) (e.g., an Ethernet or corporate network), Wide Area Networks (WANs) (e.g., the Internet), wireless data networks, cellular networks, 802.11x networks, WLANs, some other electronic data network, or some combination thereof. In various embodiments, network interface 740 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 750 may, in some embodiments, include one or more display devices, keyboards, keypads, cameras, touchpads, touchscreens, scanning devices, voice or optical recognition devices, or any other devices suitable for entering or accessing data by one or more computer systems 700. Multiple input/output devices 750 may be present in computer system 700 or may be distributed on various nodes of computer system 700. In some embodiments, similar input/output devices may be separate from computer system 700 and may interact with one or more nodes of computer system 700 through a wired or wireless connection, such as over network interface 740.

In some embodiments, the illustrated computer system may implement any of the methods described above, such as the methods illustrated by the flowchart of FIGS. 5, and 6. In other embodiments, different elements and data may be included.

Those skilled in the art will appreciate that computer system 700 is merely illustrative and is not intended to limit the scope of embodiments. In particular, the computer system and devices may include any combination of hardware or software that can perform the indicated functions of various embodiments, including computers, network devices, Internet appliances, smartphones, tablets, PDAs, wireless phones, pagers, and the like. Computer system 700 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 700 may be transmitted to computer system 700 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

What is claimed is:

1. A computer-implemented method for rapid Internet Protocol (IP) telephony communications session setup using interactive push notifications, comprising:
receiving a connection request from a first device to setup an IP telephony communications session with a second device;
transmitting a request to send a push notification message including telecommunication invitation data to the second device to notify a user of the second device of the connection request;
receiving a first response from the second device indicating acceptance of the connection request;
sending an indication to the first device that the connection request has been accepted at the second device;
receiving a second response from the second device that is used to complete the IP telephony communications session connection between the first and second devices; and
connecting the second device with the first device to establish the IP telephony communications session based on the second response.

2. The method of claim 1, wherein the telecommunication invitation data includes at least one of an Internet Protocol address, codec information, caller identification information, telephony service account information, or Session Description Protocol (SDP) data associated with the first device.

3. The method of claim 1, wherein the first response is one of a Session Description Protocol (SDP) message or a Session Initiation Protocol (SIP) message.

4. The method of claim 1, wherein the second response is a Session Initiation Protocol (SIP) message.

5. The method of claim 1, wherein sending an indication to the first device includes modifying a first media sent to the first device changes to a second media.

6. The method of claim 5, wherein the first media and the second media are audio ring back tones.

7. The method of claim 6, wherein the indication modifying the first media to the second media is sent via a media relay in a Real-time Transport Protocol (RTP) message.

8. The method of claim 1, wherein the IP telephony communications session is completed using Voice over Internet Protocol (VoIP).

9. A computer-implemented method for rapid Internet Protocol (IP) telephony communications session setup using interactive push notification, comprising:
receiving a push notification message for a request to establish an IP communication session with a first device over an IP telephony communications system;
extracting connectivity data from the push notification message;
generating a first response directed to the IP telephony communications system using the extracted connectivity data;
sending the first response to the IP telephony communications system notifying the first device that the IP communication session request was accepted;
initiating an IP telephony communication application; and
sending a second response to complete the IP telephony communications session connection with the first device.

10. The method of claim 9, wherein the connectivity data includes at least one of an Internet Protocol address, codec information, caller identification information, telephony service account information, or Session Description Protocol (SDP) data associated with the first device.

11. The method of claim 9, wherein the first response is a Session Description Protocol (SDP) message or a Session Initiation Protocol (SIP) message.

12. The method of claim 11, wherein sending the first response further comprises retrieving SDP data from the IP telephony communication application.

13. The method of claim 9, further comprising:
displaying, responsive to receiving the push notification message, an indication of an incoming call; and
receiving a selection of the indication displayed indicating acceptance of the incoming call.

14. A system for rapid Internet Protocol (IP) telephony communications session setup using interactive push notification, comprising:
a media relay configured to receive a connection request from a first device to setup an IP telephony communications session with a second device and send a first media to the first device;
a push notification payload generator configured to generate a push notification message directed to a second device with telecommunication invitation data to complete the IP telephony communications session;
at least one proxy server configured to:
receive a first response from the second device;
instruct the media relay to modify the first media sent to notify the first device of the first response;
receive a second response from the second device; and
connect the second device with the first device to establish the IP telephony communications session based on the second response.

15. The system of claim 14, wherein the telecommunication invitation data includes at least one of an Internet Protocol address, codec information, caller identification information, telephony service account information, or Session Description Protocol (SDP) data associated with the first device.

16. The system of claim 14, wherein the first response is a Session Description Protocol (SDP) message or a Session Initiation Protocol (SIP) message.

17. An apparatus for rapid Internet Protocol (IP) telephony communications session setup using interactive push notification, comprising:
a push notification handler module configured to receive a push notification message for a request to establish an IP communication session with a first device over an IP telephony communications system and extract connectivity data from the push notification message;
a response receipt module configured to generate a first response message directed to the IP telephony communications system using the extracted connectivity data and send the first response to the IP telephony communications system to notify the first device that the IP communication session request was accepted; and
a call connection module configured to send a second response to complete the IP telephony communications session connection with the first device.

18. The system of claim 17, wherein the connectivity data includes at least one of an Internet Protocol address, codec information, caller identification information, telephony service account information, or Session Description Protocol (SDP) data associated with the first device.

19. The system of claim 17, wherein the first response is a Session Description Protocol (SDP) message or a Session Initiation Protocol (SIP) message.

20. The system of claim 17, wherein the second response is a Session Initiation Protocol (SIP) message.
